(19) United States
(12) Patent Application Publication
(10) Pub. No.: US 2013/0168380 A1
(43) Pub. Date: Jul. 4, 2013

(54) HEATING STRUCTURE AND METHOD FOR PREVENTING THE OVERHEAT OF HEATING LINE

(71) Applicant: Ching-Chuan WANG, Keelung (TW)

(72) Inventor: Ching-Chuan WANG, Keelung (TW)

(21) Appl. No.: 13/343,171

(22) Filed: Jan. 4, 2012

(51) Int. Cl. H05B 1/02; H05B 3/02

(52) U.S. Cl. 219/497

(57) ABSTRACT

A heating structure and method for preventing overheat of a heating line, where the heating line includes a sensing line and a heating wire in parallel connection. The sensing line has one end connected with a processor. The heating wire has one end connected sequentially with an over-current protection element and an alternating current power's one polarity and has another end connected sequentially with a switch and the alternating current power's another polarity. The processor controls the trigger circuit to trigger the switch to be in conducting condition. Thereby, under normal condition, the heating of the heating wire is in half-wave form. When abnormal signals from the sensing line are detected by the processor, the switch is controlled to let the alternating current pass through the heating wire in full-wave form to increase the current instantaneously and disconnect the over-current protection element to stop the heating.

### TECHNICAL FIELD

The present invention relates to a heating structure and method for preventing the overheat of a heating line and, more particularly, to a heating structure and method for preventing the overheat of a heating line, which is suitable for heaters such as electric blankets and heating pads and by which it is able to disconnect the alternating current power for ceasing the heating in order to ensure the safety when the temperature of the heating line is abnormally high or the switch is broken.

### BACKGROUND

Heaters such as heating pads are widely available in the market currently. Usually, the heating of a heating line will be automatically interrupted on condition that the temperature reaches a certain value preset by users. Thereby, the temperature of the heaters can be kept within a preset range in order to provide functions such as hot compression while ensure the safety of the users.

In order to control temperature effectively, as described in a U.S. Pat. No. 5,861,610, an element of positive temperature coefficient (abbreviated as PTC hereinafter) is used as a detection line for sensing the temperature change, and consequently the element can be used together with a heating line for temperature-controlled heating. This technique also has been disclosed in other U.S. Pat. No. 6,300,597, U.S. Pat. No. 6,310,322, and U.S. Pat. No. 6,768,086. Moreover, in another U.S. Pat. No. 7,180,037, a time difference determinator circuit is used to measure the phase-shift time of different zero cross signals continually and a processor is used to calculate and output a control signal to control a trigger circuit to trigger the switch to be in conducting condition. Consequently, the temperature of the heating can be kept within a certain range.

However, the abnormal heating of the heating line will continue for a period of time until the processor of above temperature-controlled circuit stops the output of the controlling signals to prevent the trigger circuit from triggering the switch, and consequently the temperature of the heating line may go down. Accordingly, if the switch is broken, the heating of the heating line will still continue even when the processor stops the output of the controlling signals. In this case, the use of the heating line may become dangerous.

In order to overcome above shortcomings, inventor had the motive to study and develop the present invention to provide a heating structure and method for preventing the overheat of a heating line. Thereby, it is able to react swiftly and to stop the heating effectively in order to ensure the safety of the users when the temperature of the heating line is abnormally high or the switch is in short circuit condition.

### SUMMARY OF THE DISCLOSURE

An object of the present invention is to provide a heating structure and method for preventing the overheat of a heating line, where a processor is used to let the alternating current in a half-wave form to heat a heating wire under normal condition, and to let the alternating current in a full-wave form to heat a heating wire in order to increase the current instantaneously to disconnect an over-current protection element and stop the heating when the processor detects abnormal signals.

Another object of the present invention is to provide a heating structure and method for preventing the overheat of a heating line, where a processor is used to let the alternating current in a half-wave form to heat a heating wire under normal condition, and to let the alternating current in a full-wave form to heat a heating wire in order to disconnect an over-current protection element and stop the heating when the switch is in short circuit condition.

In order to achieve above objects, the present invention provides a heating structure for preventing the overheat of a heating line, comprising a heating line, an over-current protection element, a switch, a trigger circuit, and a processor. The heating line includes a heating wire, a sensing line, an insulation-and-meltable layer located between the heating wire and the sensing line, and a cladding layer covering the outer peripheries of the sensing line and the insulation-and-meltable layer. The over-current protection element is respectively connected to a first end of the heating wire and an alternating current power's first polarity, where a first node is provided between the first end of the heating wire and the over-current protection element, and the sensing line has a first end coupled to the first node. The switch is respectively connected with a second end of the heating wire and a second polarity of the alternating current power. The trigger circuit is connected with the switch and used for triggering the switch to be in conducting condition. The processor is connected with the trigger circuit and used for controlling the switch to be in conducting condition. The processor is connected with a second end of the sensing line.

Thereby, under normal condition, the processor is used to control the trigger circuit to let the alternating current in a half-wave form pass through the heating wire. When detecting abnormal signals, the processor will let the alternating current pass through the heating wire in a full-wave form in order to increase the current and disconnect the over-current protection element to stop the heating.

In implementation, the switch is a TRIAC.

In implementation, the over-current protection element is a polymer positive temperature coefficient.

In implementation, the second end of the sensing line is connected with one end of a capacitor and another end of the capacitor is connected to ground; a second node is provided between the sensing line and the capacitor; and the processor is connected to the second node.

In implementation, a diode is provided between the first node and the first end of the sensing line.

In implementation, the second end of the sensing line is connected with one end of a resistor and another end of the resistor is connected to ground; a second node is provided between the sensing line and the resistor; and the processor is connected to the second node.

The present invention also provides a method for preventing the overheat of heating line, comprising steps of:
step a. triggering the trigger circuit by the processor so as to let the alternating current pass through the heating wire in a half-wave form to begin the heating of the heating wire;
step b. turning to step e, if the switch is broken and in short circuit;
step c. turning to step f, if any abnormal signals from the sensing line are detected by the processor;
step e. letting the alternating current in a full-wave form pass through the switch and the heating wire in order to increase the current and disconnect the over-current protection element to stop the heating;
step f. controlling the switch by the processor to let the alternating current in a full-wave form pass through the heating wire in order to increase the current and disconnect the over-current protection element to stop the heating.

In implementation, when the heating wire is in short circuit condition after being in touch with the sensing line, the produced abnormal signals in the step c are abnormal phase-change signals, abnormal resistance-change signals, or abnormal alternating-current/direct-current converting signals.

The following detailed description, given by way of examples or embodiments, will best be understood in conjunction with the accompanying drawings.

### BRIEF DESCRIPTION OF THE DRAWINGS

FIG. 1 is a perspective view showing a heating line of the present invention.

FIG. 2 is a circuit block diagram showing a first embodiment of the heating structure for preventing the overheat of the heating line of the present invention.

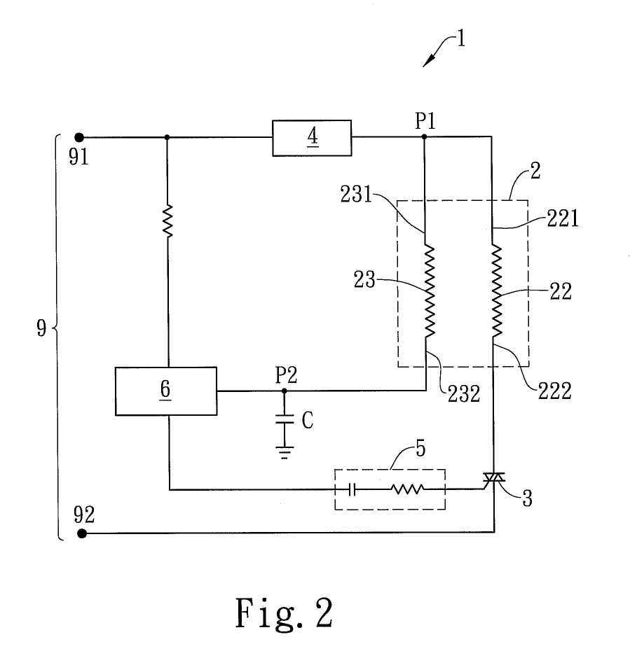

FIG. 3 is a circuit block diagram showing the first embodiment of the heating structure for preventing the overheat of the heating line of the present invention, where the heating is under normal condition.

FIG. 4 is a circuit block diagram showing the first embodiment of the heating structure for preventing the overheat of the heating line of the present invention, where it is in short circuit condition.

FIG. 5 is a circuit block diagram showing a second embodiment of the heating structure for preventing the overheat of the heating line of the present invention.

FIG. 6 is a circuit block diagram showing a third embodiment of the heating structure for preventing the overheat of the heating line of the present invention.

FIG. 7 is a flowchart showing the steps of the method for preventing the overheat of heating line of the present invention.

### DETAILED DESCRIPTION

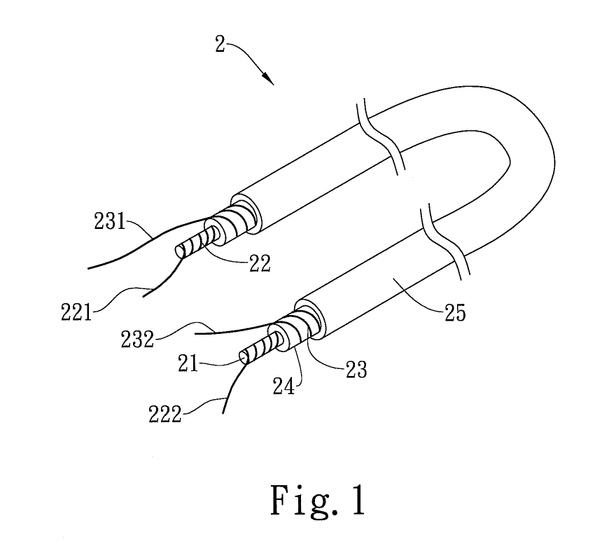

Please refer to FIGS. 1˜2, where a first embodiment of the heating structure for preventing the overheat of a heating line is illustrated. The heating structure 1 comprises a heating line 2, a switch 3, an over-current protection element 4, a trigger circuit 5, a processor 6, and a capacitor C. In this embodiment, the heating line 2 can be used as a heating element in heating devices, such as electric heating ovens and pads for hot compression.

The heating line 2 comprises a core material 21, a heating wire 22, a sensing line 23, an insulation-and-meltable layer 24, and a cladding layer 25. The heating wire 22 is coiled around the outer peripheries of the core material 21. The insulation-and-meltable layer 24 is made by polyethylene (PE) and is provided to cover the outer peripheries of the heating wire 22 and the core material 21. In implementation, the insulation-and-meltable layer 24 also can be made by other material capable of insulation and meltable in certain high-temperature range. The sensing line 23 is a positive temperature coefficient (PTC) conducting wire. Besides, the sensing line 23 is coiled around the outer peripheries of the insulation-and-meltable layer 24, so as to have the insulation-and-meltable layer 24 located between the heating wire 22 and the sensing line 23. The cladding layer 25 covers the outer peripheries of the sensing line 23 and the insulation-and-meltable layer 24.

The heating wire 2 has a first end 221 and a second end 222 reverse to the first end 221. The first end 221 of the heating wire 22 is coupled with the first polarity 91 of an alternating current power 9. The second end 222 of the heating wire 22 is connected with the main end of a TRIAC. The TRIAC is used as the switch 3. Besides, another main end of the TRIAC is coupled with the second polarity 92 of the alternating current power 9. The first and the second polarity 91, 92 are reverse to each other. Thereby, the heating wire 22, the switch 3, and the alternating current power 9 are in serial connection in order to form one loop for heating the heating wire 22.

The over-current protection element 4 is a polymer positive temperature coefficient (PPTC). Besides, the over-current protection element 4 also can be a ceramic PTC or other elements or circuits used to disconnect and thus protect a circuit under the over-current condition. One end of the over-current protection element 4 is coupled with the first polarity 91 of the alternating current power 9. Another end of the over-current protection element 4 is coupled with the first end 221 of the heating wire 22. Besides, a first node P1 is provided between the first end 221 of the heating wire 22 and the over-current protection element 4. The sensing line 23 has a first end 231 and a second end 232 reverse to the first end 231. The first end 231 of the sensing line 23 is coupled with the first node P1. The second end 232 of the sensing line 23 is connected with one end of the capacitor C. Another end of the capacitor C is connected to ground. Moreover, a second node P2 is provided between the second end 232 of the sensing line 23 and the capacitor and the second node P2 is connected with the processor 6.

In addition, the gate of the switch is connected with a resistor-capacitor (RC) circuit and the resistor-capacitor (RC) circuit is used as the trigger circuit 5. The trigger circuit 5 can further include the circuit of a relay and the trigger circuit 5 is under the control of the signals from the processor 6. Consequently, the switch 3 can be triggered by the trigger circuit 5 to be in conducting or disconnecting condition.

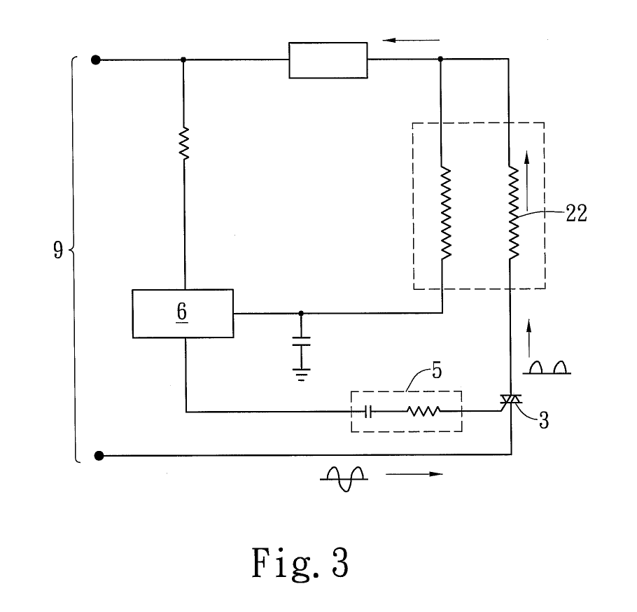

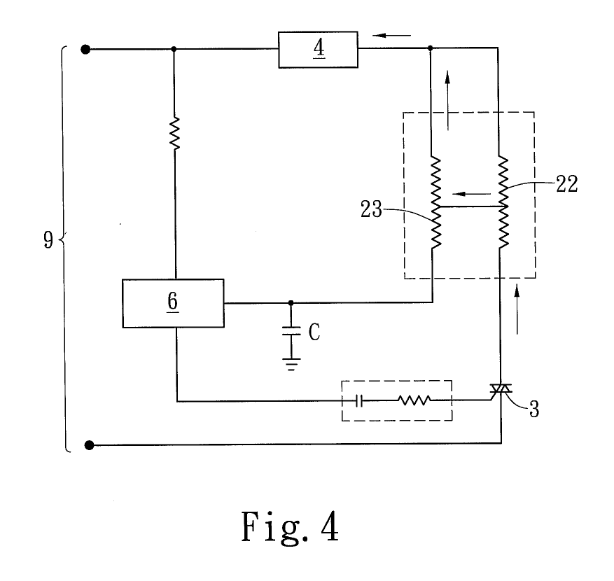

Thereby, as shown in FIG. 3, under normal heating, processor 6 will output regular signals to control the trigger circuit 5. The trigger circuit 5 intermittently triggers the switch 3, so as to let the alternating current power 9 heat the heating wire 22 in a half-wave form. As shown in FIG. 4, when something unexpected occurs, such as manually improper operation or any element becoming broken, the switch 3 may be continually triggered, and consequently the heating wire 22 will be heated continually for a period of time. When the temperature reaches up to about 120° C., the insulation-and-meltable layer 24 will be melt, so that the heating wire 22 will be in contact with the sensing line 23 to be in short circuit condition. In this moment, the total resistance of the heating wire 22 and the sensing line 23 that are in parallel connection will be changed. As a result, by means of the resistor-capacitor (RC) circuit formed by the sensing line 23 and the capacitor C, there will be a phase-change delay with a certain time for the current passing through the sensing line 23. In this case, some split flow from the alternating current power 9 flows into the processor and can be used as a standard for comparison. Therefore, the processor 6 will detect the abnormal phase change signals via comparison and then control the switch 3 to let the alternating current in a full-wave form pass through the heating wire 22. By this way, the current passing through the heating wire 22 will double. When the current value is increased instantaneously to be higher than the value preset by the polymer positive temperature coefficient (PPTC), the over-current protection element 4 will be made disconnected as a result of the property of the polymer positive temperature coefficient (PPTC). Consequently, the circuit will be in disconnecting condition so as to stop the heating of the heating wire 22.

In above situation, the switch 3 is continually triggered and the heating wire 22 is continually heated. In another situation, the temperature is abnormally high under the influence of the switch 3 since the switch 3 is in short circuit condition. In this case, the alternating current will in full-wave form pass through the heating wire 22 in order to increase the current instantaneously and disconnect the over-current protection element 4 and then the circuit.

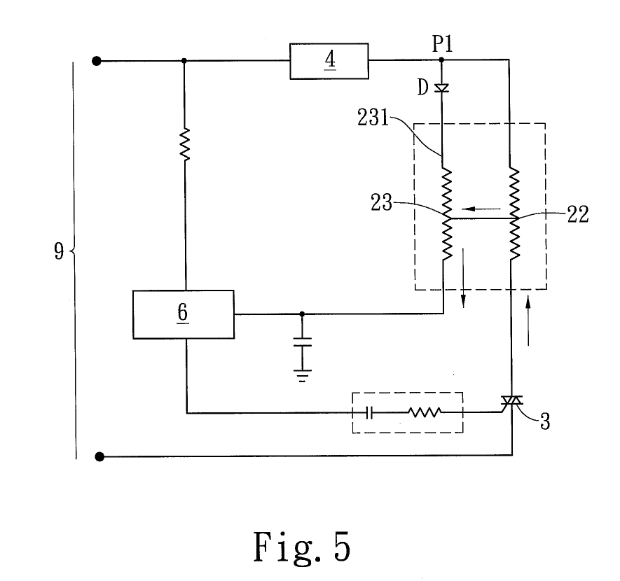

Please refer to FIG. 5, where a second embodiment of the heating structure for preventing the overheat of a heating line according to the present invention is illustrated. Compared with the first embodiment, the difference between the two embodiments lies in that: in the second embodiment, a diode D is provided between the first node P1 and the first end 231 of the sensing line 23. Thereby, when the heating wire 22 is in short circuit condition after being in contact with the sensing line 23, the direct-current signals originally passing through the sensing line 23 will be converted to be alternating-current signals. When the processor 6 detects these abnormal signals, the processor 6 will control the switch 3 to let the alternating current in a full-wave form pass through the heating wire 22, so as to disconnect the over-current protection element 4 and then the circuit.

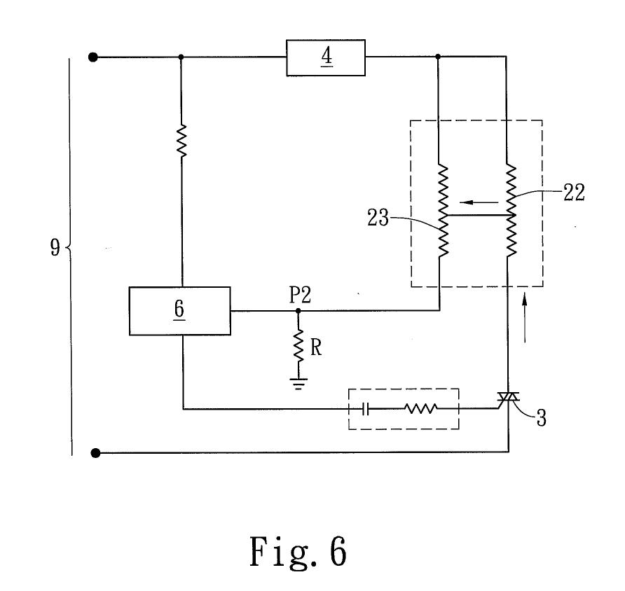

As shown in FIG. 6, where a third embodiment of the heating structure for preventing the overheat of a heating line according to the present invention is illustrated. Compared with the first embodiment, the difference between the two embodiments lies in that: in the third embodiment, the second node P2 is coupled with one end of the resistor R and another end of the resistor is connected to ground. Thereby, when the heating wire 22 is in short circuit condition after being in contact with the sensing line 23, the resistance value of the second node P2 will be altered. When the processor 6 detects these abnormal resistance-change signals, it will control the switch 3 to let the alternating current in a full-wave form pass through the heating wire 22 in order to disconnect the over-current protection element 4 and then the circuit.

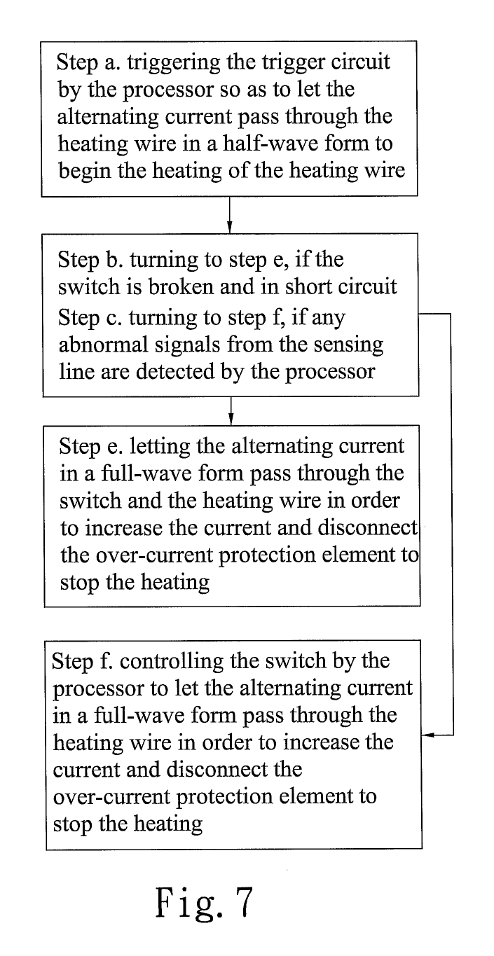

As shown in FIG. 7, a flowchart of the method for preventing the overheat of a heating line is illustrated. As shown in FIGS. 1˜2, the heating line 2 includes a heating wire 22, a sensing line 23, an insulation-and-meltable layer 24 located between the heating wire 22 and the sensing line 23, and a cladding layer 25 covering the outer peripheries of the sensing line 23. The heating wire 22 has a first end 221 in serial connection with an over-current protection element 4 and the first polarity 91 of an alternating current power 9. The heating wire 22 has a second end 222 in serial connection with a switch 3 and the second polarity 92 of the alternating current power 9. The switch 3 is triggered to be in conducting condition by a trigger circuit 5 that is controlled by a processor 6. The method comprises following steps:
step a. triggering the trigger circuit 5 by the processor 6 so as to let the alternating current pass through the heating wire 22 in a half-wave form to begin the heating of the heating wire 22;
step b. turning to step e, if the switch 3 is broken and in short circuit condition;
step c. turning to step f, if any abnormal signals from the sensing line 23 are detected by the processor 6;
step e. letting the alternating current in a full-wave form pass through the switch 3 and the heating wire 22 in order to increase the current and disconnect the over-current protection element 4 to stop the heating; and
step f. controlling the switch 3 by the processor 6 to let the alternating current in a full-wave form pass through the heating wire 22 in order to increase the current and disconnect the over-current protection element 4 to stop the heating.

In above method, the abnormal signals in the step c can be abnormal phase-change signals produced when the heating wire 22 is in short circuit condition after being in touch with the sensing line 23. In implementation, the abnormal signals in the step c also can be abnormal resistance-change signals produced when the heating wire 22 is in short circuit condition after being in touch with the sensing line 23. Or, as shown in FIG. 5, the abnormal signals in the step c can be abnormal direct-current/alternating-current converting signals produced when the heating wire 22 is in short circuit condition after being in touch with the sensing line 23.

Therefore, the present invention has following advantages:
1. According to the present invention, the processor can detect abnormal signals when the heating wire is in short circuit condition after being in contact with the sensing line. Under the control of the processor, the trigger circuit will trigger the switch to let the alternating current in a full-wave form pass through the heating wire in order to increase instantaneously the current and disconnect the over-current protection element and then the circuit. Thereby, it takes less time to react and can ensure the safety of the users effectively.
2. According to the present invention, by means of the over-current protection element, when the switch is broken and in short circuit condition, the current passing through the heating wire can be increased instantaneously so as to disconnect the over-current protection element and then disconnect the circuit. Thereby, it is able to enhance the safety of the products.

As disclosed in above descriptions and attached drawings, the present invention provides a heating structure and method for preventing the overheat of a heating line, which are capable of swift reaction and are able to stop the heating of the heating wire to ensure the safety of the users when the temperature of the heating wire is abnormally high or the switch does not perform its normal function. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A heating structure for preventing the overheat of a heating line, comprising:
a heating line, including a heating wire, a sensing line, an insulation-and-meltable layer located between the heating wire and the sensing line, and a cladding layer covering the outer peripheries of the sensing line and the insulation-and-meltable layer;
an over-current protection element, respectively connected to a first end of the heating wire and an alternating current power's first polarity, where a first node is provided between the first end of the heating wire and the over-current protection element, and the sensing line's first end is coupled to the first node;
a switch, respectively connected to a second end of the heating wire and a second polarity of the alternating current power;
a trigger circuit, connected with the switch and used for triggering the switch to be in conduction condition; and
a processor, connected with the trigger circuit and used for controlling the switch to be in conducting state, where the processor is connected with a second end of the sensing line, so that the processor is able to control the trigger circuit to let the alternating current in a half-wave form pass through the heating wire under normal condition; when abnormal signals are detected, the processor is able to let the alternating current pass through the heating wire in a full-wave form in order to increase the current and disconnect the over-current protection element to stop the heating.

2. The heating structure for preventing the overheat of a heating line as claimed in claim 1, wherein the second end of the sensing line is connected with one end of a capacitor and another end of the capacitor is connected to ground; a second node is provided between the second end of the sensing line and one end of the capacitor; and the processor is connected to the second node.

3. The heating structure for preventing the overheat of a heating line as claimed in claim 2, wherein a diode is provided between the first node and the first end of the sensing line.

4. The heating structure for preventing the overheat of a heating line as claimed in claim 1, wherein the second end of the sensing line is connected with one end of a resistor and another end of the resistor is connected to ground; a second node is provided between the second end of the sensing line and one end of the resistor; and the processor is connected to the second node.

5. The heating structure for preventing the overheat of a heating line as claimed in claim 1, wherein the switch is a TRIAC.

6. The heating structure for preventing the overheat of a heating line as claimed in claim 5, wherein the second end of the sensing line is connected with one end of a capacitor and another end of the capacitor is connected to ground; a second node is provided between the second end of the sensing line and one end of the capacitor; and the processor is connected to the second node.

7. The heating structure for preventing the overheat of a heating line as claimed in claim 6, wherein a diode is provided between the first node and the first end of the sensing line.

8. The heating structure for preventing the overheat of a heating line as claimed in claim 5, wherein the second end of the sensing line is connected with one end of a resistor and another end of the resistor is connected to ground; a second node is provided between the second end of the sensing line and one end of the resistor; and the processor is connected to the second node.

9. The heating structure for preventing the overheat of a heating line as claimed in claim 1, wherein the over-current protection element is a polymer positive temperature coefficient.

10. The heating structure for preventing the overheat of a heating line as claimed in claim 9, wherein the second end of the sensing line is connected with one end of a capacitor and another end of the capacitor is connected to ground; a second node is provided between the second end of the sensing line and one end of the capacitor; and the processor is connected to the second node.

11. The heating structure for preventing the overheat of a heating line as claimed in claim 10, wherein a diode is provided between the first node and the first end of the sensing line.

12. The heating structure for preventing the overheat of a heating line as claimed in claim 9, wherein the second end of the sensing line is connected with one end of a resistor and another end of the resistor is connected to ground; a second node is provided between the second end of the sensing line and one end of the resistor; and the processor is connected to the second node.

13. A method for preventing the overheat of a heating line, where the heating line includes a heating wire, a sensing line, an insulation-and-meltable layer located between the heating wire and the sensing line, and a cladding layer covering the outer peripheries of the sensing line and the insulation-and-meltable layer; the heating wire has a first end in serial connection with an over-current protection element and an alternating current power's first polarity; the heating wire has a second end in serial connection with a switch and the alternating current power's second polarity; and the switch is triggered to be in conducting condition by a trigger circuit that is controlled by a processor; the method comprising steps of:
step a. triggering the trigger circuit by the processor so as to let the alternating current pass through the heating wire in a half-wave form to begin the heating of the heating wire;
step b. turning to step e, if the switch is broken and in short circuit condition;
step c. turning to step f, if any abnormal signals from the sensing line are detected by the processor;
step e. letting the alternating current in a full-wave form pass through the switch and the heating wire in order to increase the current and disconnect the over-current protection element to stop the heating;
step f. controlling the switch by the processor to let the alternating current in a full-wave form pass through the heating wire in order to increase the current and disconnect the over-current protection element to stop the heating.

14. The method for preventing the overheat of a heating line as claimed in claim 13, wherein the abnormal signals in the step c are abnormal phase-change signals produced when the heating wire is in short circuit condition after being in touch with the sensing line.

15. The method for preventing the overheat of a heating line as claimed in claim 13, wherein the abnormal signals in the step c are abnormal resistance-change signals produced when the heating wire is in short circuit condition after being in touch with the sensing line.

16. The method for preventing the overheat of a heating line as claimed in claim 13, wherein the abnormal signals in the step c are abnormal alternating-current/direct-current converting signals produced when the heating wire is in short circuit condition after being in touch with the sensing line.
